(19) United States
(12) Patent Application Publication
(10) Pub. No.: US 2007/0300234 A1
(43) Pub. Date: Dec. 27, 2007

(54) SELECTING APPLICATION MESSAGES FROM AN ACTIVE FEED ADAPTER AND A BACKUP FEED ADAPTER FOR APPLICATION-LEVEL DATA PROCESSING IN A HIGH SPEED, LOW LATENCY DATA COMMUNICATIONS ENVIRONMENT

(76) Inventors: Eliezer Dekel, Haifa (IL); John J. Duigenan, New York, NY (US); Gidon Gershinsky, Haifa (IL); Avraham Harpaz, Haifa (IL); Nir Naaman, Haifa (IL); Foluso O. Okunseinde, Austin, TX (US); Hilary A. Pike, College Station, TX (US); Yoav Tock, Nesher (IL); Cornell G. Wright, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/426,819

(22) Filed: Jun. 27, 2006

(51) Int. Cl. G06F 9/46

(52) U.S. Cl. 719/313

(57) ABSTRACT

Selecting application messages from redundant feed adapters for application-level data processing in a high speed, low latency data communications environment, including brokering establishment of an active message stream to a subscribing client device from an active feed adapter; brokering establishment of a backup message stream to the subscribing client device from a backup feed adapter; receiving active transport packets in a transport engine of the subscribing client device from the active feed adapter; receiving and buffering backup transport packets; identifying a missing active transport packet; determining whether a corresponding backup transport packet for the missing active transport packet has been received from the backup transport adapter; and replacing the missing active transport packet with the corresponding backup transport packet for further data processing if the corresponding backup transport packet for the missing active transport packet has been received.

### BACKGROUND OF THE INVENTION

1. Field of the Invention

The field of the invention is data processing, or, more specifically, methods, apparatus, and products for selecting application messages from an active feed adapter and a backup feed adapter for application-level data processing in a high speed, low latency data communications environment.

2. Description of Related Art

Messaging environments are generally available to provide data communication between message sending devices and message receiving devices using application messages. An application message is a quantity of data that includes one or more data fields and is passed from a message producer installed on a message sending device to a message consumer installed on a message receiving device. An application message is a form of message recognized by application software operating in the application layer of a data communication protocol stack—as contrasted for example with a transport message or network message, which are forms of messages recognized in the transport layer and the network layer respectively. An application message may represent, for example, numeric or textual information, images, encrypted information, and computer program instructions.

A messaging environment may support point-to-point messaging, publish and subscribe messaging, or both. In a point-to-point messaging environment, a message producer may address an application message to a single message consumer. In a publish and subscribe messaging environment, a message producer may publish an application message to a particular channel or topic and any message consumer that subscribes to that channel or topic receives the message. Because message producers and message consumers communicate indirectly with each other via a channel or topic in a publish and subscribe environment, message transmission is decoupled from message reception. As a consequence, neither producers nor consumers need to maintain state about each other, and dependencies between the interacting participants are reduced or eliminated. A publish and subscribe environment may, therefore, allow message publishers and message subscribers to operate asynchronously.

For further explanation of a messaging environment, FIG. 1 sets forth a block diagram illustrating a typical messaging environment for data communications that includes a message sending device (100), a message receiving device (104), and a message administration server (102). The message sending device (100) is a computer device having installed upon it a message producer (110), a set of computer program instructions configured for transmitting application messages to the message administration server (102) for delivery to a message receiving device. In the example of FIG. 1, the message producer (110) transmits application messages to the message administration server (102) on a message stream (106). The message sending device (100) may produce the transmitted messages by generating the application messages from data of the message sending device itself or data received from some other source. The message receiving device (104) is a computer device having installed upon it a message consumer (112), a set of computer program instructions configured for receiving application messages from the message administration server (102). In the example of FIG. 1, the message consumer (112) receives the application messages from the message administration server (102) on a message stream (108). In the example of FIG. 1, the message stream (106) and the message stream (108) are data communication channels implemented using, for example, the User Datagram Protocol (‘DEP’) and the Internet Protocol (‘IP’).

In either a point-to-point messaging environment or a publish and subscribe messaging environment, the application messages transmitted from message sending devices to message receiving devices typically pass through the message administration server (102). The message administration server (102) is computer device having installed upon it a message administration module (114), computer program instructions configured for administering the messages transmitted from the message producer (110) to the message consumer (112). Examples of message administration modules may include the IBM WebSphere® MQ, the Open Message Queue from Sun Microsystems, and the OpenJMS from The OpenJMS Group. In a point-to-point messaging environment, the message administration module (114) provides message queuing for the message consumer (112) as the message administration module (114) receives application messages addressed to the consumer (112) from various message providers. In a publish and subscribe messaging environment, the message administration module (114) administers the various channels or topics to which message producers publish and message consumers subscribe. In either message environment, the message administration module (114) may also provide security services to ensure that the only messages arriving at the messaging consumer (112) from the message producer (110) are those messages that the message consumer (112) is authorized to receive and that the message producer (110) is authorized to send. Moreover, the message administration module (114) may also coordinate providing to the message consumer backup messages from a backup message producer in the event that a failure occurs on the message producer (110).

Current messaging environments such as, for example, the one described above with reference to FIG. 1, have certain drawbacks. Application messages transmitted to a message administration server from a message sending device for delivery to a message receiving device are delayed in the message administration server until the message administration server can process the messages. The message processing that occurs in the message administration server increases the overall messaging latency of the messaging environment and decreases the overall speed for transmitting data in the data communications environment. Messaging latency is the time period beginning when the message producer transmits an application message and ending when the message consumer receives the application message.

In many data communication environments, even slight increases in messaging latency are costly. Consider, for example, a financial market data environment. A financial market data environment is a data processing environment used to communicate information about financial markets and participants in financial markets. In a financial market data environment, an application message is commonly referred to as a ‘tick’ and represents financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security. In a financial market data environment, a message producer may provide quotes for the purchase or sale of financial securities based on real-time financial market conditions, and a message consumer may buy and sell financial securities based on financial quotes. When a message consumer buys or sells a financial security based on the quoted price provided by the message producer, the ability of a message consumer to obtain the bid or ask in the quote for the financial security is largely influenced by messaging latency in the financial market data environment. The higher the messaging latency, the less likely a buy or sell order generated by the message consumer will execute at or near the price stated in the financial quote. In fact, a highly volatile security may fluctuate in price dramatically over a time period of a few seconds.

Current solutions to reduce messaging latency are to remove the message administration server from the messaging environment. In such current solutions, the message sending devices send application messages directly to message receiving devices. The drawback to such current solutions is that removing the message administration server removes the administration functionality provided by the message administration server from the messaging environment. Current solutions, therefore, effectively offer no solution in messaging environments where the administrative functions of a message administration server are required. Consider again the financial market data environment example from above. In such an exemplary financial market data environment, consider that a message receiving device is only authorized to receive financial quotes on certain financial securities or only authorized to receive financial quotes that are at least fifteen minutes old. Removing the message administration server from such a financial market data environment removes the ability to administer the messages received by the message receiving device from the message sending device in the financial market data environment.

An additional drawback to current messaging environments, such as, for example, the one describe above with reference to FIG. 1, involves the situation in which a message administration server receives application messages from both an active message sending device and a backup message sending device. In such a situation, the message administration server provides the messages from the active message sending device to the message receiving devices while buffering the message from the backup message sending device until the active message sending device fails. When the active message sending device fails, the buffered messages received from the backup message sending device are available in the message administration server to provide to the message receiving devices. In current messaging environments, however, the message administration server does not efficiently utilize the buffered messages from the backup message sending device while the active message sending device is operational. For example, the message administration server often does not receive one or more of the messages from the active message sending device due to packet losses in a network connecting the message administration server and the active message sending device. In response, the message administration server typically sends a negative acknowledgement (‘NAK’) to the active message sending device indicating that the message administration server did not receive a particular packet containing the missed application messages. The message administration server must then wait for the active message sending device to respond to the NAK before receiving the missed application message even though a corresponding duplicate of the missed application message may be available in the buffer containing the messages from the backup message sending device.

In addition, the message administration servers in current messaging environments do not efficiently utilize the buffered messages from the backup message sending device because the message administration server only utilizes the message stream from the backup message sending device when the active message sending device fails. Often, however, the message stream from the backup message sending device to the message administration server performs more efficiently than the message stream from the active message sending device.

### SUMMARY OF THE INVENTION

Methods, apparatus, and products are disclosed for selecting application messages from an active feed adapter and a backup feed adapter for application-level data processing in a high speed, low latency data communications environment that include brokering, by a stream administration server, establishment of an active message stream to a subscribing client device from an active feed adapter, the active message stream comprising active application messages; brokering, by the stream administration server, establishment of a backup message stream to the subscribing client device from a backup feed adapter, the backup message stream comprising backup application messages representing duplicates of the active application messages; receiving active transport packets in a transport engine of the subscribing client device from the active feed adapter, each active transport packet including one or more active application messages, each active transport packet characterized by an active packet sequence number, the active application messages from the active transport packets used for further data processing by an application of the subscribing client device; receiving and buffering backup transport packets in the transport engine of the subscribing client device from the backup feed adapter, each backup transport packet including one or more backup application messages, each backup transport packet characterized by a backup packet sequence number and representing a duplicate of a corresponding active transport packet; identifying, by the transport engine in dependence upon the active packet sequence numbers, a missing active transport packet; determining, by the transport engine, whether a corresponding backup transport packet for the missing active transport packet has been received from the backup transport adapter; and replacing, by the transport engine, the missing active transport packet with the corresponding backup transport packet for further data processing if the corresponding backup transport packet for the missing active transport packet has been received from the backup feed adapter.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a typical messaging environment for data communications.

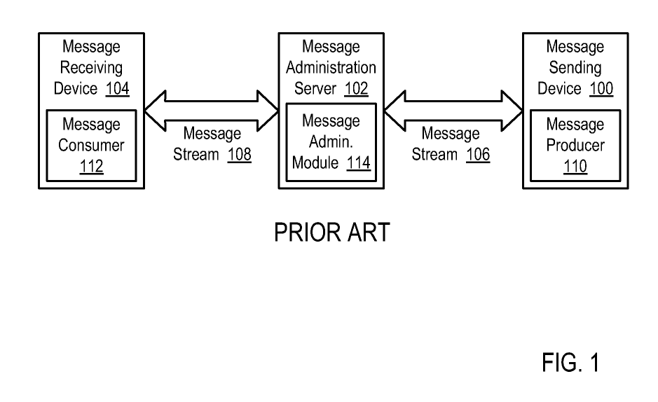

FIG. 2 sets forth a network and block diagram illustrating an exemplary computer data processing system for selecting application messages from an active feed adapter and a backup feed adapter for application-level data processing in a high speed, low latency data communications environment according to exemplary embodiments of the present invention.

FIG. 3 sets forth a block diagram of automated computing machinery comprising an example of a subscribing client device useful in selecting application messages from an active feed adapter and a backup feed adapter for application-level data processing in a high speed, low latency data communications environment according to exemplary embodiments of the present invention.

FIG. 4 sets forth a flowchart illustrating an exemplary method for selecting application messages from an active feed adapter and a backup feed adapter for application-level data processing in a high speed, low latency data communications environment according to exemplary embodiments of the present invention.

FIG. 5 sets forth a flowchart illustrating a further exemplary method for selecting application messages from an active feed adapter and a backup feed adapter for application-level data processing in a high speed, low latency data communications environment according to exemplary embodiments of the present invention.

FIG. 6 sets forth a flowchart illustrating a further exemplary method for selecting application messages from an active feed adapter and a backup feed adapter for application-level data processing in a high speed, low latency data communications environment according to exemplary embodiments of the present invention.

FIG. 7 sets forth a flowchart illustrating a further exemplary method for selecting application messages from an active feed adapter and a backup feed adapter for application-level data processing in a high speed, low latency data communications environment according to exemplary embodiments of the present invention.

FIG. 8 sets forth a flowchart illustrating a further exemplary method for selecting application messages from an active feed adapter and a backup feed adapter for application-level data processing in a high speed, low latency data communications environment according to exemplary embodiments of the present invention.

### DETAILED DESCRIPTION OF EXEMPLARY EMBODIMENTS

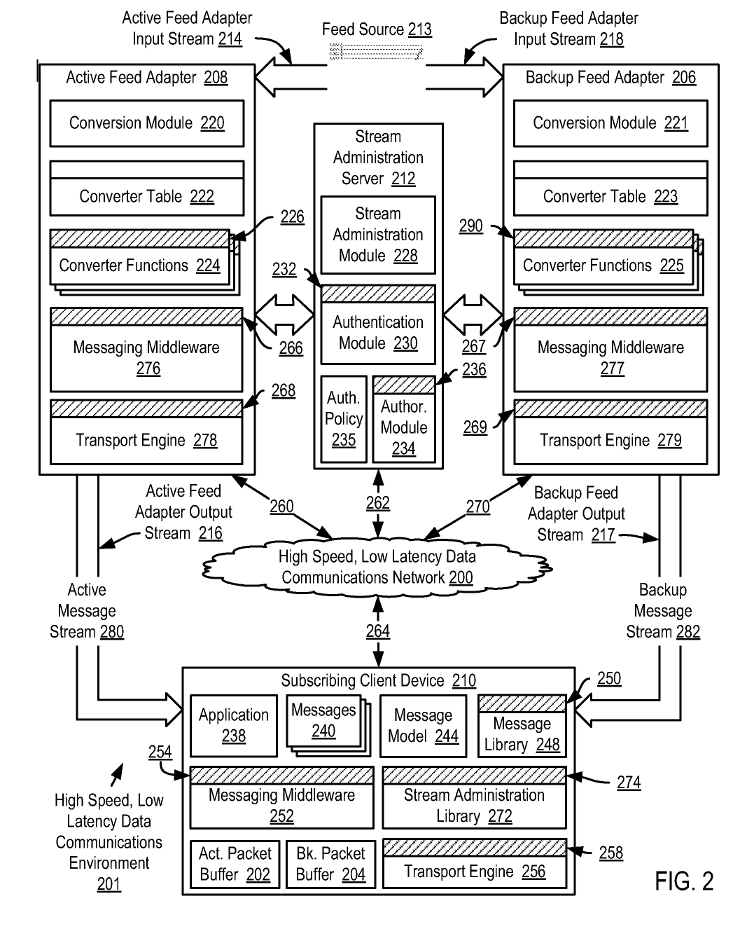

Exemplary methods, apparatus, and products for selecting application messages from an active feed adapter and a backup feed adapter for application-level data processing in a high speed, low latency data communications environment according to embodiments of the present invention are described with reference to the accompanying drawings, beginning with FIG. 2. FIG. 2 sets forth a network and block diagram illustrating an exemplary computer data processing system for selecting application messages from an active feed adapter (208) and a backup feed adapter (206) for application-level data processing in a high speed, low latency data communications environment (201) according to embodiments of the present invention. The system of FIG. 2 operates generally for selecting application messages from an active feed adapter and a backup feed adapter for application-level data processing in a high speed, low latency data communications environment according to embodiments of the present invention as follows: A stream administration server (212) brokers establishment of an active message stream (280) to a subscribing client device (210) from an active feed adapter (208), where the active mess age stream (280) includes active application messages. The stream administration server (212) brokers establishment of a backup message stream (282) to the subscribing client device (210) from a backup feed adapter (206), and the backup message stream (282) includes backup application messages representing duplicates of the active application messages. The transport engine (256) receives active transport packets of the subscribing client device (210) from the active feed adapter (208), where each active transport packet includes one or more active application messages. Readers will note that in this specification a transport packet that includes one application message may refer to a transport packet that includes an entire application message or a fragment of an application message. Each active transport packet is characterized by an active packet sequence number, and the active application messages from the active transport packets are used for further data processing by an application of the subscribing client device (210). The transport engine (256) receives from the backup feed adapter (206) and buffers backup transport packets of the subscribing client device (210). Each backup transport packet (416) includes one or more backup application messages, and each backup transport packet is characterized by a backup packet sequence number and represents a duplicate of a corresponding active transport packet. As mentioned above, readers will note that in this specification a transport packet that includes one application message may refer to a transport packet that includes an entire application message or a fragment of an application message. The transport engine (256) identifies, in dependence upon the active packet sequence numbers, a missing active transport packet and determines whether a corresponding backup transport packet for the missing active transport packet has been received from the backup transport adapter (206). The transport engine (256) replaces the missing active transport packet with the corresponding backup transport packet for further data processing if the corresponding backup transport packet for the missing active transport packet has been received from the backup feed adapter (206).

The high speed, low latency data communications environment (201) illustrated in FIG. 2 includes a high speed, low latency data communications network (200). The network (200) includes an active feed adapter (208), a backup feed adapter (206) a stream administration server (212), and a subscribing client device (210), as well as the infrastructure for connecting such devices (206, 208, 212, 210) together for data communications. The network (200) of FIG. 2 is termed ‘high speed, low latency’ because the application messages sent between devices connected to the network (200) on message streams administered by the stream administration server (212) bypass the stream administration server (212). For example, the application messages on the active message stream (280) from the active feed adapter (208) to the subscribing client device (210) bypass the stream administration server (212). Similarly, the application messages on the backup message stream (282) from the backup feed adapter (206) to the subscribing client device (210) bypass the stream administration server (212). Although such messages are not delayed for processing in the stream administration server (212), the stream administration server (212) retains administration of the streams (280, 282) between devices connected to the high speed, low latency data communications network (200).

Further contributing to the high speed, low latency nature of network (200), readers will note that the network (200) does not include a router, that is a computer networking device whose primary function is to forward data packets across a network toward their destinations. Rather, each device (206, 208, 212, 210) provides its own routing functionality for data communication through a direct connection with the other devices connected to the network (200). Because the network (200) does not include a computer networking device dedicated to routing data packets, the network (200) of FIG. 2 may be referred to as a ‘minimally routed network.’ Although the exemplary network (200) illustrated in FIG. 2 does not include a router, such a minimally routed network is for explanation only. In fact, some high speed, low latency networks useful in selecting application messages from an active feed adapter and a backup feed adapter for application-level data processing in a high speed, low latency data communications environment according to embodiments of the present invention may include a router.

As mentioned above, the high speed, low latency data communications environment (201) depicted in FIG. 2 includes two message streams (280, 282). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 2 includes a stream administration server (212) connected to the high speed, low latency data communications network (200) through a wireline connection (262). The stream administration server (212) of FIG. 2 is a computer device having installed upon it a stream administration module (228), an authentication module (230), an authorization module (234), and an authorization policy (235). A stream administration module (228) is a set of computer program instructions configured for selecting application messages from an active feed adapter and a backup feed adapter for application-level data processing in a high speed, low latency data communications environment according to embodiments of the present invention. The stream administration module (228) operates generally for selecting application messages from an active feed adapter and a backup feed adapter for application-level data processing in a high speed, low latency data communications environment according to embodiments of the present invention by brokering establishment of an active message stream (280) to a subscribing client device (210) from an active feed adapter (208) and brokering establishment of a backup message stream (282) to the subscribing client device (210) from a backup feed adapter (206). In addition, the stream administration module (228) administers the message streams by providing security services such as authenticating the subscribing client device (210) and authorizing the subscribing client device (210) to receive application messages from the feed adapters (206, 208) on the message streams (280, 282).

The authentication module (230) of FIG. 2 is a set of computer program instructions capable of providing authentication security services to the stream administration module (228) through an exposed authentication application programming interface (‘API’) (232). Authentication is a process verifying the identity of an entity. In the exemplary system of FIG. 2, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 2 is a set of computer program instructions capable of providing authorization security services to the stream administration module (228) through an exposed authorization API (236). Authorization is a process of only allowing resources to be used by resource consumers that have been granted authority to use the resources. In the example of FIG. 2, the authorization module (234) identifies the application messages that the subscribing client device (210) is authorized to receive on the message streams (280, 282). The authorization module (234) of FIG. 2 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 2, active feed adapter (208) is connected to the high speed, low latency data communications network (200) through a wireline connection (260). The active feed adapter (208) is a computer device having the capabilities of converting application messages on a active feed adapter input stream (214) having a first format to application messages on a active feed adapter output stream (216) having a second format and transmitting the application messages on the active feed adapter output stream (216) to subscribing client devices. The active feed adapter input stream (214) is a message stream from a feed source to the active feed adapter (208). The active feed adapter output stream (216) is a message stream administered by the stream administration server (212) from the active feed adapter (208) to the subscribing client device (210).

In the example of FIG. 2, the active feed adapter (208) receives application messages on the active feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘OCTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center^{SM} which is an electronic screen-based equity securities market in the United States. In a financial market data environment, a feed adapter input stream is referred to as a ‘financial market data feed.’

The active feed adapter (208) of FIG. 2 has installed upon it a conversion module (220), a converter table (222), converter functions (224), messaging middleware (276), and a transport engine (278). The conversion nodule (220) is a set of computer program instructions for converting application messages received on the active feed adapter input stream (214) having a first format into application messages having a second format for transmission to subscribing devices on the active feed adapter output stream (216). The conversion module (220) converts application messages from the first format to the second format according to the converter table (222).

The converter table (222) of FIG. 2 is a table that specifies the converter functions (224) capable of converting the application message from one format to another format. Utilizing multiple converter tables, the conversion module (220) may convert messages from a variety of input formats to a variety of output formats. In the example of FIG. 2, the converter table (222) specifies the converter functions (224) capable of converting the application message received from the active feed adapter input stream (214) having the first format to application messages having the second format for transmission to subscribing client devices on the active feed adapter output stream (216). The converter table (222) of FIG. 2 may be implemented using a structured document such as, for example, an eXtensible Markup Language (‘XML’) document.

The converter functions (224) of FIG. 2 are functions capable of converting data fields in an application message from one format to another format or converting values of data fields from one value to another value. Converter functions (224) may, for example, convert a 16-bit integer to a 32-bit integer, convert a number stored in a string field to a 64-bit double floating point value, increase the value of a particular data field by one, or any other conversion as will occur to those of skill in the art. The conversion module (220) accesses the converter functions (224) through a set of converter function APIs (226) exposed by the converter functions (224).

Before the conversion module (220) of FIG. 2 performs data processing on the application messages, the conversion module (220) receives the messages from the feed source (213). The conversion module (220) of FIG. 2 may receive the messages through a receiving transport engine (not shown) of the active feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received messages directly to the conversion module (220) or to the messaging middleware (276), which in turn, provides the source stream messages to the conversion module.

The messaging middleware (276) of FIG. 2 is a software component that provides high availability services between the active feed adapter (208), the backup feed adapter (206), the subscribing client device (210), and the feed source (213) and provides synchronization services between the active feed adapter (208) and the backup feed adapter (206). Messaging middleware (276) of FIG. 2 provides synchronization services through a data communications channel between the active feed adapter (208) and the backup feed adapter (206). After the conversion module (220) of FIG. 2 receives application messages from the feed source (213) and performs data processing on the application messages, the messaging middleware (276) receives the application messages from the conversion module (220) and provides the received application messages to the transport engine (278) for transmission to a subscribing client device on the active feed adapter output stream (216). The conversion module (220) interacts with the messaging middleware (276) through a messaging middleware API (266) exposed by the messaging middleware (276).

The transport engine (278) of FIG. 2 is a software component operating in the transport and network layers of the OSI protocol stack promulgated by the International Organization for Standardization. The transport engine (278) provides data communications services between network-connected devices. The transport engine may be implemented according to the UDP/JP protocols, TCP/IP protocols, or any other data communications protocols as will occur to those of skill in the art. The transport engine (278) includes a set of computer program instructions capable of encapsulating the application messages provided by the messaging middleware (276) into packets and transmitting the packets through the active message stream (280) to the subscribing client device (210). The messaging middleware (276) operates the transport engine (278) through a transport API (268) exposed by the transport engine (278).

In the exemplary system of FIG. 2, backup feed adapter (206) is connected to the high speed, low latency data communications network (200) through a wireline connection (270). The backup feed adapter (206) is a computer device having the capabilities of converting backup messages on a backup feed adapter input stream (218) having a first format to backup messages on a backup feed adapter output stream (217) having a second format and transmitting the backup messages on the backup feed adapter output stream (217) to subscribing client devices. The backup feed adapter input stream (218) is a message stream from the feed source (213) to the backup feed adapter (206). The backup feed adapter output stream (217) is a message stream administered by the stream administration server (212) from the backup feed adapter (206) to the subscribing client device (210).

The backup feed adapter (206) of FIG. 2 has installed upon it a conversion module (221), a converter table (223), converter functions (225) that expose converter function APIs (290), messaging middleware (277) that exposes messaging middleware API (267), and a transport engine (279) that exposes a transport engine API (269). The components installed on the backup feed adapter (206) operate in a manner similar to the components installed on the active feed adapter (208).

The subscribing client device (210) in exemplary system of FIG. 2 connects to the high speed, low latency data communications network (200) through a wireline connection (264). The subscribing client device (210) of FIG. 2 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 2, the subscribing client device (210) has installed upon it an application (238), a message library (248), messaging middleware (252), a stream administration library (272), a transport engine (256), an active packet buffer (202), and a backup packet buffer (204). The active packet buffer (202) of FIG. 2 is computer memory for buffering the active transport packets received from the active feed adapter (208) on the active message stream (280). The backup packet buffer (204) of FIG. 2 is computer memory for buffering the backup transport packets received from the backup feed adapter (206) on the backup message stream (282).

The application (238) of FIG. 2 is a software component that processes data contained in the application messages (240) received from one of the feed adapters (208, 206). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

In the example of FIG. 2, the application messages (240) have a format specified in a message model (244). The message model (244) is metadata that defines the structure and the format of the application messages (240) received on the message streams (280, 282). The message model (244) may be attached to and transmitted along with the application messages (240) received from the feed adapters (208, 206). More often, however, both the subscribing client device (210) and the feed adapters (208, 206) may receive the message model (244) from the stream administration server (212) when the stream administration server (212) brokers the message streams (280, 282). A message model may be implemented using a structured document, such as, for example, an XML document, a Java object, C++ object, or any other implementation as will occur to those of skill in the art.

The application (238) of FIG. 2 processes the data contained in the application messages (240) using the message library (248). The message library (248) is a set of functions that are computer program instructions for creating, accessing, and manipulating messages (240) according to a message model (244). The message library (248) is accessible to the application (238) through a message API (250) exposed by the message library (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the application (238) of the subscribing client device (210) may request to subscribe to messages from a feed adapter, modify an existing message subscription, or cancel a message subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystem™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java RMI allows a Java client to access a remote Java object just like any other local Java object.

Before the application (238) processes the data contained in the messages (240), the application (238) receives the messages (240) from the messaging middleware (252), which, in turn, receives the application messages (240) from one of the feed adapter (208, 206) through the transport engine (256). The messaging middleware (252) is a software component that provides high availability services between the subscribing client device, the feed adapter (208), and the backup feed adapter (206). In addition, the messaging middleware (252) provides message administration services for the stream administration server (212). Such message administration services may include restricting the ability of the application (238) to send and receive messages on a message stream to messages that satisfy certain constraints. The application (238) and the stream administration library (272) interact with the messaging middleware (252) through a messaging middleware API (254).

The transport engine (256) of FIG. 2 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software module that includes a set of computer program instructions for receiving packets through the message streams (280, 282) from the feed adapters (208, 206), unencapsulating the application messages from the received packets, and providing the application messages to the messaging middleware (252). The messaging middleware (252) operates the transport engine (256) through a transport API (258) exposed by the transport engine (256).

In addition to the transport services mentioned above, the transport engine (256) of FIG. 2 also operates generally for selecting application messages from an active feed adapter and a backup feed adapter for application-level data processing in a high speed, low latency data communications environment according to embodiments of the present invention. The transport engine (256) of FIG. 2 operates for selecting application messages from an active feed adapter (208) and a backup feed adapter (206) for application-level data processing in a high speed, low latency data communications environment (201) according to embodiments of the present invention by receiving active transport packets from the active feed adapter (208), each active transport packet including one or more active application messages, each active transport packet characterized by an active packet sequence number, the active application messages from the active transport packets used for further data processing by an application (238) of the subscribing client device (210); receiving and buffering backup transport packets from the backup feed adapter (206), each backup transport packet including one or more backup application messages, each backup transport packet characterized by a backup packet sequence number and representing a duplicate of a corresponding active transport packet; identifying, in dependence upon the active packet sequence numbers, a missing active transport packet; determining whether a corresponding backup transport packet for the missing active transport packet has been received from the backup transport adapter (206); and replacing the missing active transport packet with the corresponding backup transport packet for further data processing if the corresponding backup transport packet for the missing active transport packet has been received from the backup feed adapter (206).

The transport engine (256) of FIG. 2 also operates generally for selecting application messages from an active feed adapter (208) and a backup feed adapter (206) for application-level data processing in a high speed, low latency data communications environment (201) according to embodiments of the present invention by measuring performance of the active message stream (280) and performance of the backup message stream (282); and switching from further data processing with active application messages to further data processing with the backup application messages in dependence upon the performance of the active message stream (280), the performance of the backup message stream (282), and predetermined performance criteria.

The servers and other devices illustrated in the exemplary system of FIG. 2 are for explanation, not for limitation. Devices useful in selecting application messages from an active feed adapter and a backup feed adapter for application-level data processing in a high speed, low latency data communications environment according to embodiments of the present invention may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 2 are for explanation, not for limitation. Although the connections to the network (200) of FIG. 2 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 2, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 2.

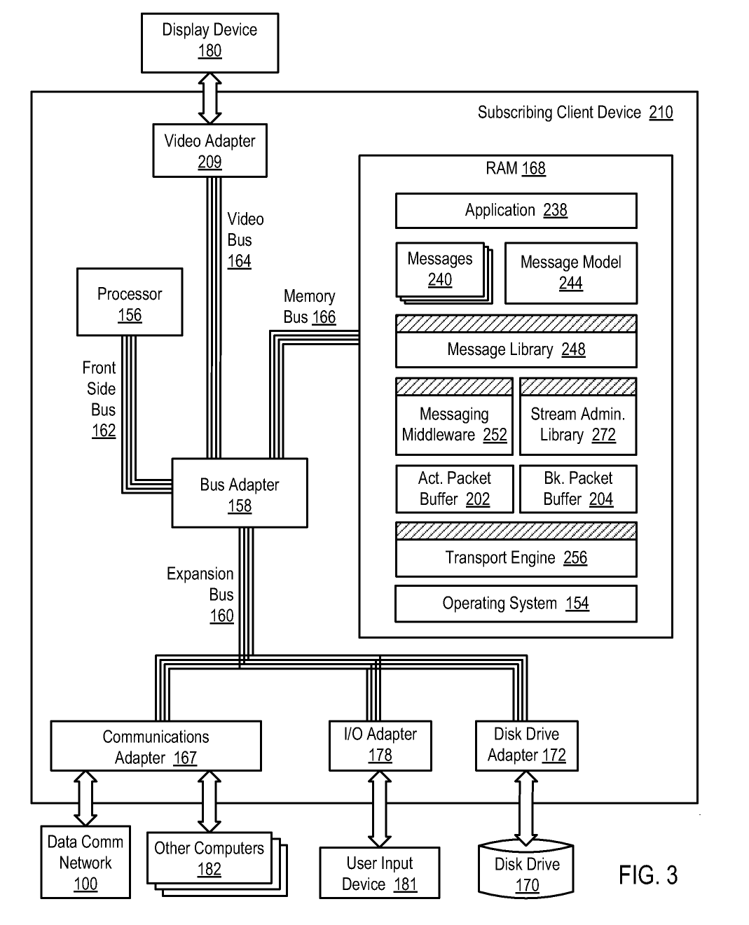

Selecting application messages from an active feed adapter and a backup feed adapter for application-level data processing in a high speed, low latency data communications environment in accordance with the present invention in some embodiments may be implemented with one or more subscribing client devices, stream administration servers, and feed adapters, computers, that is, automated computing machinery. For further explanation, therefore, FIG. 3 sets forth a block diagram of automated computing machinery comprising an example of a subscribing client device (210) useful in selecting application messages from an active feed adapter and a backup feed adapter for application-level data processing in a high speed, low latency data communications environment according to embodiments of the present invention. The subscribing client device (210) of FIG. 3 includes at least one computer processor (156) or ‘CPU’ as well as random access memory (168) (‘RAM’) which is connected through a high speed memory bus (166) and bus adapter (158) to processor (156) and to other components of the subscribing client device.

Stored in RAM (168) are an application (238), application messages (240), message model (244), a message library (248), a messaging middleware (252), a stream administration library (272), a transport engine (256), an active packet buffer (202), and a backup packet buffer (204). Each application message (240) is a quantity of data that includes one or more data fields and is transmitted from one device to another on a message stream. Application messages are typically created and processed by applications operating in application layers above the network and transport layers of a network protocol stack. As mentioned above, an application message may represent numeric or textual information, images, encrypted information, computer program instructions, and so on. In a financial market data environment, for example, a message is commonly referred to as a ‘tick’ and represents financial market data such as, for example, financial quotes or financial news. Each application message (240) may be implemented using a structured document such as, for example, an XML document, a Java object, C++ object, or any other implementation as will occur to those of skill in the art. The message model (244) is metadata that defines the structure and format of the messages (240). The message model (244) may also be implemented using a structured document such as, for example, an XML document, a Java object, C++ object, or any other implementation as will occur to those of skill in the art.

In the example of FIG. 3, the active packet buffer (202) is computer memory for buffering active transport packets received from an active feed adapter on an active message stream. The backup packet buffer (204) of FIG. 3 is computer memory for buffering the backup transport packets received from the backup feed adapter on a backup message stream. The application (238), the message library (248), the messaging middleware (252), the stream administration library (272), and the transport engine (256) illustrated in FIG. 3 are software components, that is computer program instructions, that operate as described above with reference to FIG. 2.

Also stored in RAM (168) is an operating system (154). Operating systems useful in subscribing client devices according to embodiments of the present invention include UNIX™, Linux™, Microsoft NT™, IBM's AIX™, IBM's is/OS™, and others as will occur to those of skill in the art. The operating system (154), the application (238), the messages (240), the message model (244), the message library (248), the messaging middleware (252), the transport engine (256), the active packet buffer (202), and the backup packet buffer (204) in the example of FIG. 3 are shown in RAM (168), but many components of such software typically are stored in non-volatile memory also, for example, on a disk drive (170).

The exemplary subscribing client device (210) of FIG. 3 includes bus adapter (18), a computer hardware component that contains drive electronics for high speed buses, the front side bus (162), the video bus (164), and the memory bus (166), as well as drive electronics for the slower expansion bus (160). Examples of bus adapters useful in subscribing client devices useful according to embodiments of the present invention include the Intel Northbridge, the Intel Memory Controller Hub, the Intel Southbridge, and the Intel I/O Controller Huh. Examples of expansion buses useful in subscribing client devices useful according to embodiments of the present invention may include Peripheral Component Interconnect (‘PCI’) buses and PCI Express (‘PCIe’) buses.

The exemplary subscribing client device (210) of FIG. 3 also includes disk drive adapter (172) coupled through expansion bus (160) and bus adapter (158) to processor (156) and other components of the exemplary subscribing client device (210). Disk drive adapter (172) connects non-volatile data storage to the exemplary subscribing client device (210) in the form of disk drive (170). Disk drive adapters useful in subscribing client devices include Integrated Drive Electronics (‘IDE’) adapters, Small Computer System Interface (‘SCSI’) adapters, and others as will occur to those of skill in the art. In addition, non-volatile computer memory may be implemented for a subscribing client device as an optical disk drive, electrically erasable programmable read-only memory (so-called ‘EEPROM’ or ‘Flash’ memory), RAM drives, and so on, as will occur to those of skill in the art.

The exemplary subscribing client device (210) of FIG. 3 includes one or more input/output (‘I/O’) adapters (178). I/O adapters in subscribing client devices implement user-oriented input/output through, for example, software drivers and computer hardware for controlling output to display devices such as computer display screens, as well as user input from user input devices (181) such as keyboards and mice. The exemplary subscribing client device (210) of FIG. 3 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary subscribing client device (210) of FIG. 3 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for selecting application messages from an active feed adapter and a backup feed adapter for application-level data processing in a high speed, low latency data communications environment according to embodiments of the present invention include modems for wired dial-up communications, IEEE 802.3 Ethernet adapters for wired data communications network communications, and IEEE 802.11b adapters for wireless data communications network communications.

Although FIG. 3 is discussed with reference to exemplary subscribing client devices, readers will note that automated computing machinery comprising exemplary stream administration servers and exemplary feed adapters useful in selecting application messages from an active feed adapter and a backup feed adapter for application-level data processing in a high speed, low latency data communications environment according to embodiments of the present invention are similar to the exemplary subscribing client device (210) of FIG. 3. That is, such exemplary stream administration servers and feed adapters include one or more processors, bus adapters, buses, RAM, video adapters, communications adapters, I/O adapters, disk drive adapters, and other components similar to the exemplary subscribing client device (210) of FIG. 3 as will occur to those of skill in the art.

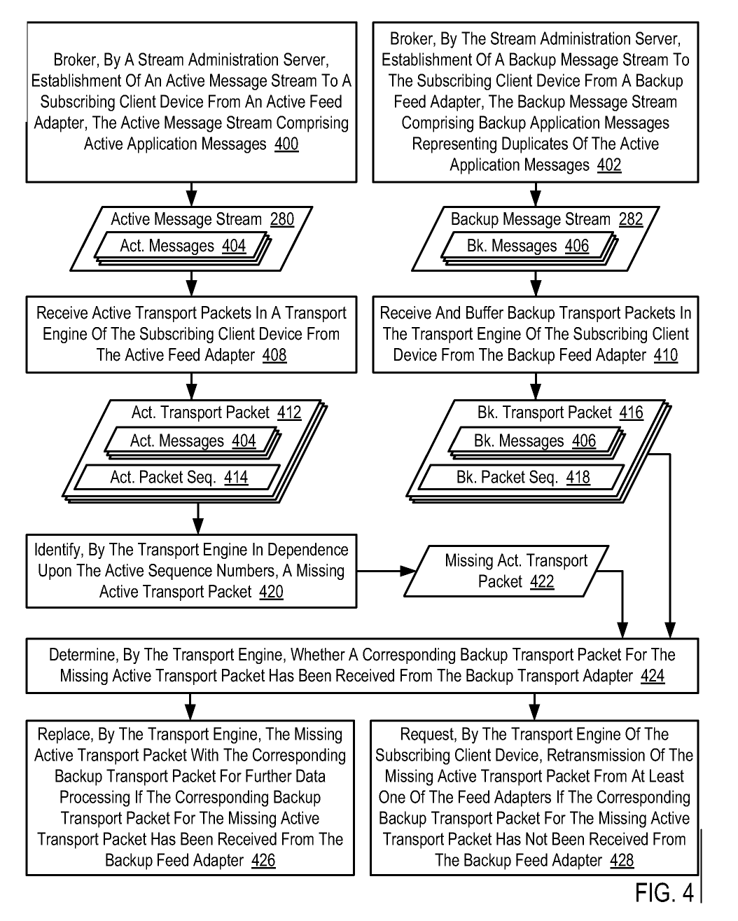

For further explanation, FIG. 4 sets forth a flowchart illustrating an exemplary method for selecting application messages from an active feed adapter and a backup feed adapter for application-level data processing in a high speed, low latency data communications environment according to embodiments of the present invention.

The method of FIG. 4 includes brokering (400), by a stream administration server, establishment of an active message stream (280) to a subscribing client device from an active feed adapter. The active message stream (280) represents a data communication channel between a communications endpoint of a subscribing client device and a communications endpoint of a feed adapter. A message stream may be implemented as a multicast data communication channel using the UDP/IP protocols or a unicast data communication channel using TCP/IP protocols as discussed above with reference to FIG. 2.

In the example of FIG. 4, the active message stream (280) includes active application messages (404). The active application messages (404) represent application messages received by a subscribing client device from an active feed adapter. Each active application message (404) of FIG. 4 may be characterized by an active message sequence number that uniquely identifies the active application message among other application messages transmitted from a particular active feed adapter. An active message sequence number also provides the relative transmission order for a particular active application message with respect to the other active application messages transmitted from the active feed adapter.

In the method of FIG. 4, brokering (400), by a stream administration server, establishment of an active message stream (280) to a subscribing client device from an active feed adapter may be carried out by receiving a subscription request from a subscribing client device to subscribe to messages from a feed adapter. The subscription request may be implemented as an XML document, a call to a member method of a RMI object on the subscribing client device, or any other implementation as will occur to those of skill in the art. The subscription request may include topics of the messages that the subscribing client device requests to receive from the feed adapter. A topic represents the characteristics of the messages that the subscribing client device requests. Using a topic, a subscribing client device may specify the group of messages for receipt from the feed adapter. In a financial market data environment, for example, a subscribing client device may use a topic to request ticks from an OPRA feed source that contains quotes of an IBM option traded on the Chicago Board Options Exchange (‘CBOE’) that includes the best bid and best ask for the IBM option on the CBOE.

Brokering (400), by a stream administration server, establishment of an active message stream (280) to a subscribing client device from an active feed adapter according to the method of FIG. 4 may also include providing the subscribing client device a destination address for the feed adapter. The destination address for the feed adapter is a multicast address or a unicast address used by the subscribing client device to listen for messages from a feed adapter. Using the destination address provided by the stream administration server, the subscribing client device may establish the active message stream (280) from the feed adapter to the subscribing client device.

Before the stream administration server provides the destination address for the feed adapter, the stream administration server in the example of FIG. 4 may perform several security services to ensure that the subscribing client device only receives messages from the feed adapter for which the subscribing client device is authorized to receive. In the method of FIG. 4, brokering (400), by a stream administration server, establishment of an active message stream (280) to a subscribing client device from an active feed adapter may also be carried out by authenticating the subscribing client device and authorizing the subscribing client device to receive messages from the feed adapter on the message stream (280). Authenticating the subscribing client device may be carried out by verifying client security credentials provided by the subscribing client device with the subscription request. The client security credentials may be implemented as a digital signature in a public key infrastructure, a security token, or any other security data as will occur to those of skill in the art for authenticating the identity of the originator of the subscription request. Authorizing the subscribing client device to receive messages from the feed adapter on the message stream (280) may be carried out by identifying the privileges associated with the authenticated subscribing client device in dependence upon an authorization policy. An authorization policy is a set of rules governing the privileges of authenticated subscribing client devices requesting to receive data from a feed adapter.

The method of FIG. 4 also includes brokering (402), by the stream administration server, establishment of a backup message stream (282) to the subscribing client device from a backup feed adapter. In the example of FIG. 4, brokering (402), by the stream administration server, establishment of a backup message stream (282) to the subscribing client device from a backup feed adapter may be carried out in a manner similar to brokering (400), by a stream administration server, establishment of an active message stream (280) to a subscribing client device from an active feed adapter as described above.

The backup message stream (282) of FIG. 4 represents a data communication channel between a communications endpoint of a subscribing client device and a communications endpoint of a feed adapter. In the example of FIG. 4, the backup message stream (282) includes backup application messages (406) that represent duplicates of the active application messages (404). The backup application messages (406) represent application messages received by a subscribing client device from a backup feed adapter. Each backup application message (406) of FIG. 4 may be characterized by a backup message sequence number that uniquely identifies the backup application message among other application messages transmitted from a particular backup feed adapter. A backup message sequence number also provides the relative transmission order for a particular backup application message with respect to the other backup application messages transmitted from the backup feed adapter.

The method of FIG. 4 also includes receiving (408) active transport packets (412) in a transport engine of the subscribing client device from the active feed adapter. Each active transport packet (412) represents a quantity of data transmitted as a whole from one device to another on a network. Examples of transport packets may include TCP packets or UDP datagrams. Each active transport packet (412) of FIG. 4 is characterized by an active packet sequence number (414). The active packet sequence number (414) uniquely identifies an active transport packet among other active transport packets transmitted from a particular active feed adapter. The active packet sequence number (414) also provides the relative transmission order for a particular active transport with respect to the other active transport packets transmitted from the active feed adapter.

Each active transport packet (412) of FIG. 4 includes one or more active application messages (404). As mentioned above, readers will note that in this specification a transport packet that includes one application message may refer to a transport packet that includes an entire application message or a fragment of an application message. The active application messages (404) from the active transport packets (412) are used for further data processing by an application of the subscribing client device. That is, the transport engine, operating in the network and transport layers of a network protocol stack, unencapsulates the active application messages (404) from the active transport packets (412) and passes the active application messages (404) to application software operating in protocol layers above the network and transport layers of the network protocol stack for further data processing.

The method of FIG. 4 also includes receiving and buffering (410) backup transport packets (416) in the transport engine of the subscribing client device from the backup feed adapter. Each backup transport packet (416) represents a quantity of data transmitted as a whole from one device to another on a network. Each backup transport packet (416) of FIG. 4 includes one or more backup application messages (406) that represent duplicates of corresponding active application messages (404). As mentioned above, a transport packet that includes one application message may refer to a transport packet that includes an entire application message or a fragment of an application message in this specification. The transport engine of the subscribing client device may utilize the buffered backup transport packets (416) by replacing a missing active transport packet (412) with a corresponding backup transport packet (416). The transport engine of the subscribing client device may also utilize the buffered backup transport packets (416) by switching from further data processing with the active application messages (404) to the backup application messages (406).

Each backup transport packet (416) of FIG. 4 is characterized by a backup packet sequence number (418). The backup packet sequence number (418) uniquely identifies a backup transport packet among other backup transport packets transmitted from a particular backup feed adapter. The backup packet sequence number (418) also provides the relative transmission order for a particular backup transport with respect to the other backup transport packets transmitted from the backup feed adapter.

Each backup transport packet (416) of FIG. 4 represents a duplicate of a corresponding active transport packet (412). The backup feed adapter may produce backup transport packets (416) that duplicate the active transport packets (412) produced by the active feed adapter by synchronizing the backup feed adapter with the active feed adapter using a data communication channel between messaging middleware of each feed adapter. To ensure that the backup feed adapter maps the same backup application messages (406) into the same backup transport packet (416) as the active feed adapter, the backup feed adapter may produce the backup transport packets (416) later in time than the active feed adapter produces the active transport packets (412). The time delay between when the active feed adapter produces an active transport packet and when the backup feed adapter produces a corresponding backup transport packet allows the backup feed adapter to synchronize with the active feed adapter.

The method of FIG. 4 also includes identifying (420), by the transport engine in dependence upon the active packet sequence numbers (414), a missing active transport packet (422). The missing active transport packet (422) represents an active transport packet (412) not received by the subscribing client device. Identifying (420), by the transport engine in dependence upon the active packet sequence numbers (414), a missing active transport packet (422) according to the method of FIG. 4 may be carried out by counting down from a predetermined timeout period when an active transport packet is received in the transport engine of the subscribing client device that has a value for the active packet sequence number (414) that is higher than the previous highest value by at least two. Identifying (420), by the transport engine in dependence upon the active packet sequence numbers (414), a missing active transport packet (422) according to the method of FIG. 4 may further be carried out by identifying, as the missing active transport packet (422) after the predetermined timeout period, any active transport packet having values for the active packet sequence numbers that are between the values for the active packet sequence number of the active transport packet having previous highest value for an active packet sequence number and the active transport packet having a value for an active packet sequence number that is higher than the previous highest value by at least two.

The method of FIG. 4 also includes determining (424), by the transport engine, whether a corresponding backup transport packet for the missing active transport packet (422) has been received from the backup transport adapter. Determining (424), by the transport engine, whether a corresponding backup transport packet for the missing active transport packet (422) has been received from the backup transport adapter according to the method of FIG. 4 may be carried out by identifying, in a backup packet buffer, a backup transport packets (416) having a value for the backup packet sequence number (418) that matches the value for the active packet sequence number of the missing active transport packet (422). If a backup transport packet is identified, then a corresponding backup transport packet for the missing active transport packet (422) has been received from the backup transport adapter. A corresponding backup transport packet for the missing active transport packet (422) has not been received from the backup transport adapter if a backup transport packet is not identified.

The method of FIG. 4 includes replacing (426), by the transport engine, the missing active transport packet (422) with the corresponding backup transport packet for further data processing if the corresponding backup transport packet for the missing active transport packet (422) has been received from the backup feed adapter. Replacing (426), by the transport engine, the missing active transport packet (422) with the corresponding backup transport packet for further data processing according to the method of FIG. 4 may be carried out by unencapsulating the backup application messages from the buffered backup transport packet that corresponds to the missing active transport packet (422) and providing the unencapsulated backup application messages to application software operating in a layer above the transport and network layers of a network protocol stack.

The method of FIG. 4 includes requesting (428), by the transport engine of the subscribing client device, retransmission of the missing active transport packet (422) from at least one of the feed adapters if the corresponding backup transport packet for the missing active transport packet (422) has not been received from the backup feed adapter. Requesting (428), by the transport engine of the subscribing client device, retransmission of the missing active transport packet (422) from at least one of the feed adapters according to the method of FIG. 4 may be carried out by transmitting, from the transport engine to each feed adapter, a message transmission request for the missing active transport packet (422). The message transmission request may be implemented as a negative acknowledgement (‘NAK’) indicating that the subscribing client device did not receive the missing active transport packet (422). The message transmission request may specify the missing active transport packet (422) using the active packet sequence number of the missing active transport packet (422).

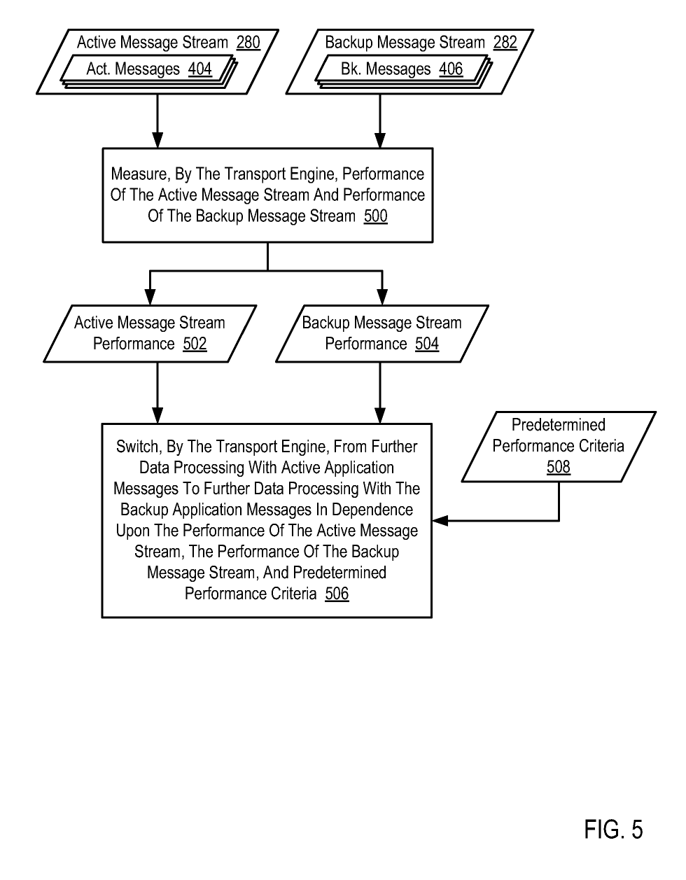

As mentioned above, the subscribing client device may utilize the buffered backup transport packets by switching from further data processing with the active application messages to the backup application messages even when the active feed adapter producing the active application messages has not failed. The transport engine may switch from further data processing with the active application messages to the backup application messages based on the performance of the active message stream and the backup message stream. For further explanation, therefore, FIG. 5 sets forth a flowchart illustrating a further exemplary method for selecting application messages from an active feed adapter and a backup feed adapter for application-level data processing in a high speed, low latency data communications environment according to embodiments of the present invention that includes measuring (500), by the transport engine, performance (502) of the active message stream (280) and performance (504) of the backup message stream (282).

The performance (502) of the active message stream (280) represents a performance attribute of the active message stream (280). Examples of performance attributes of the active message stream (280) may include the number of transmission errors occurring over a time period, the messaging latency of the stream, the most recently received active transport packet in the subscribing client device from the active feed adapter on the active message stream (280), and any other performance attributes of the active message stream (280) as will occur to those of skill in the art. Similarly, the performance (504) of the backup message stream (282) represents a performance attribute of the backup message stream (282).

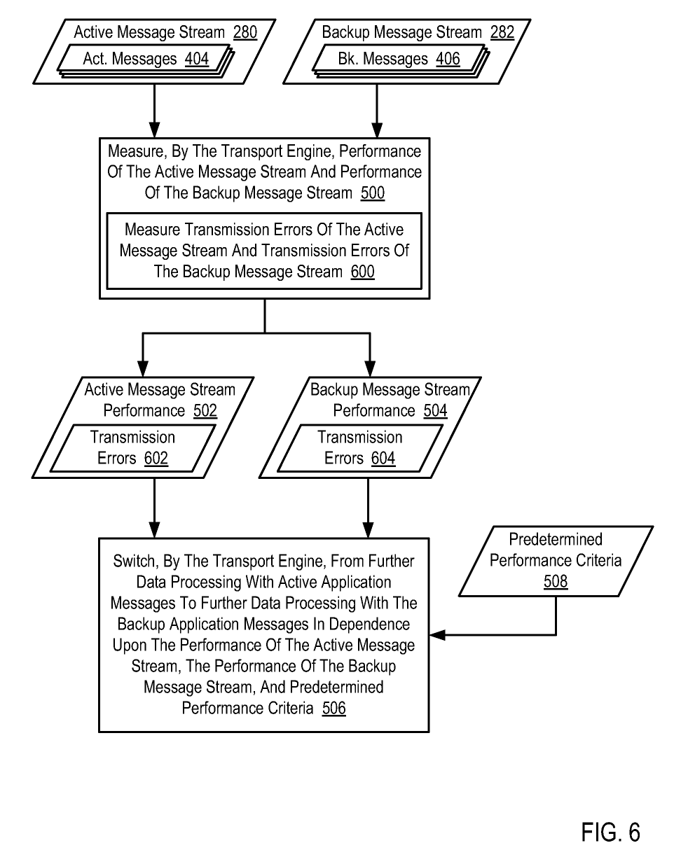

Measuring (500), by the transport engine, performance (502) of the active message stream (280) and performance (504) of the backup message stream (282) according to the method of FIG. 5 may be carried out by measuring transmission errors of the active message stream and transmission errors of the backup message stream, measuring latency of the active message stream and latency of the backup message stream, and identifying the most recently received active transport packet in the subscribing client device from the active feed adapter on the active message stream and the most recently received backup transport packet in the subscribing client device from the backup feed adapter on the backup message stream as described below with reference to FIGS. 6, 7, and 8.

The method of FIG. 5 also includes switching (506), by the transport engine, from further data processing with active application messages (404) to further data processing with the backup application messages (406) in dependence upon the performance (502) of the active message stream (280), the performance (504) of the backup message stream (282), and predetermined performance criteria (508). The predetermined performance criteria (508) represents a performance threshold indicating when the performance cost of not switching to utilize the backup application messages (406) for further data processing instead of the active application messages (404) exceeds the performance costs of switching to utilize the backup application messages (406) for further data processing instead of the active application messages (404). The performance cost of not switching to utilize the backup application messages (406) for further data processing instead of the active application messages (404) may include, for example, increased overall messaging latency in a high speed, low latency data communications environment. The performance costs of switching to utilize the backup application messages (406) for further data processing instead of the active application messages (404) may include, for example, the processing overhead of eliminating duplicate packets encountered during the switch.

In the method of FIG. 5, switching (506), by the transport engine, from further data processing with active application messages (404) to further data processing with the backup application messages (406) in dependence upon the performance (502) of the active message stream (280), the performance (504) of the backup message stream (282), and predetermined performance criteria (508) may be carried out by determining whether to switch in dependence upon the performance (502) of the active message stream (280), the performance (504) of the backup message stream (282), and predetermined performance criteria (508). Determining whether to switch from further data processing with active application messages (404) to further data processing with the backup application messages (406) may be carried out by comparing the performance (502) of the active message stream (280) and the performance (504) of the backup message stream (282) to the predetermined performance criteria (508) according to a switching algorithm. The switching algorithm may, for example, specify switching if a value for the predetermined performance criteria (508) exceeds the value arrived at by subtracting the value for the performance (502) of the active message stream (280) from the value for the performance (504) of the backup message stream (282).

In the method of FIG. 5, switching (506), by the transport engine, from further data processing with active application messages (404) to further data processing with the backup application messages (406) may further be carried out by identifying the next active transport packet from which the transport engine will extract active application messages for further data processing, and utilizing the backup application messages for further data processing from the backup transport packets having backup packet sequence numbers with values greater than or equal to the active packet sequence number of the identified active transport packet if a determination is made to switch. As explained above, the active transport packets received in the transport engine of the subscribing client device from the active feed adapter are buffered in an active packet buffer, and the backup transport packets received in the transport engine of the subscribing client device from the backup feed adapter are buffered in a backup packet buffer.

As mentioned above, measuring, by the transport engine, performance of the active message stream and performance of the backup message stream may be carried out by measuring transmission errors of the active message stream and transmission errors of the backup message stream. For further explanation, therefore, FIG. 6 sets forth a flowchart illustrating a further exemplary method for selecting application messages from an active feed adapter and a backup feed adapter for application-level data processing in a high speed, low latency data communications environment according to embodiments of the present invention that includes measuring (600) transmission errors (602) of the active message stream (280) and transmission errors (604) of the backup message stream (282).

In the example of FIG. 6, the performance (502) of the active message stream (280) includes transmission errors (602) of the active message stream (280). Transmission errors (602) of the active message stream (280) represent active transport packets from an active feed adapter that arrive in the transport engine corrupted or do arrive in the transport engine at all. In response to such corrupted or missing transport packets, the transport engine sends a NAK to the active feed adapter requesting retransmission of the corrupted or missing active transport packets.

Similarly, the performance (504) of the backup message stream in the example of FIG. 6 includes transmission errors (604) of the backup message stream (282). Transmission errors (604) of the backup message stream (282) represent backup transport packets from an backup feed adapter that arrive in the transport engine corrupted or do arrive in the transport engine at all. In response to such corrupted or missing transport packets, the transport engine sends a NAK to the backup feed adapter requesting retransmission of the corrupted or missing backup transport packets.

Measuring (500), by the transport engine, performance (502) of the active message stream (280) and performance (504) of the backup message stream (282) according to the method of FIG. 6 includes measuring (600) transmission errors (602) of the active message stream (280) and transmission errors (604) of the backup message stream (282). In the method of FIG. 6, measuring (600) transmission errors (602) of the active message stream (280) and transmission errors (604) of the backup message stream (282) may be carried out by measuring the number of NAKs sent by the transport engine of the subscribing client device to the active feed adapter and the backup feed adapter over a specified period of time. The number of NAKs sent by the transport engine of the subscribing client device to the active feed adapter over a specified period of time represents the transmission errors (602) of the active message stream (280). The number of NAKs sent by the transport engine of the subscribing client device to the backup feed adapter over a specified period of time represents the transmission errors (604) of the backup message stream (282).

The example of FIG. 6 also includes switching (506), by the transport engine, from further data processing with active application messages (404) to further data processing with the backup application messages (406) in dependence upon the performance (502) of the active message stream (280), the performance (504) of the backup message stream (282), and predetermined performance criteria (508). Switching (506), by the transport engine, from further data processing with active application messages (404) to further data processing with the backup application messages (406) in dependence upon the performance (502) of the active message stream (280), the performance (504) of the backup message stream (282), and predetermined performance criteria (508) may be carried out by switching, by the transport engine, from further data processing with active application messages (404) to further data processing with the backup application messages (406) if the difference between the transmission errors (602) of the active message stream (280) and the transmission errors (604) of the backup message stream (282) exceeds the predetermined performance criteria (508).

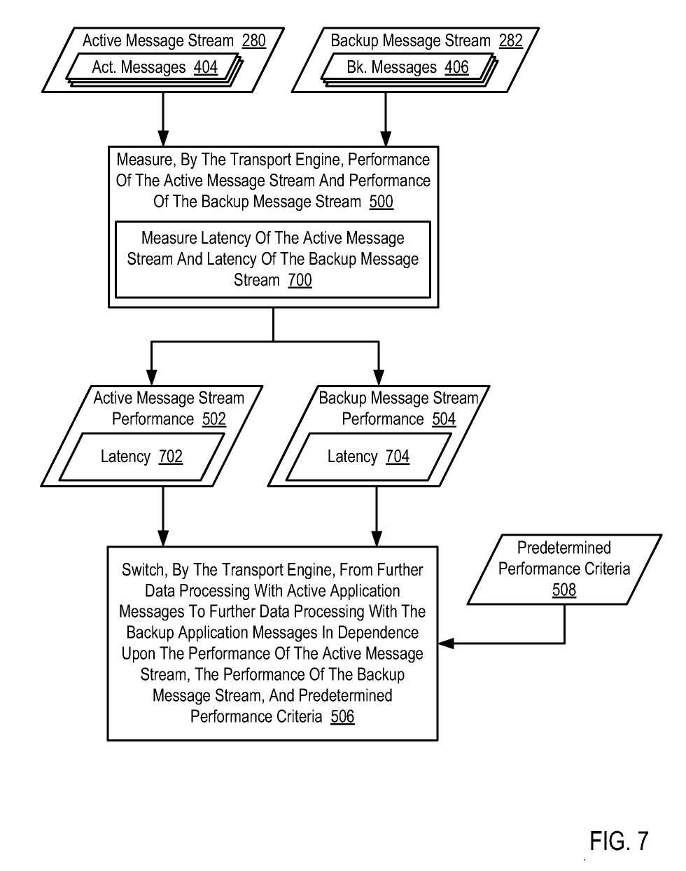

As mentioned above, measuring, by the transport engine, performance of the active message stream and performance of the backup message stream may be carried out by measuring latency of the active message stream and latency of the backup message stream. For further explanation, therefore, FIG. 7 sets forth a flowchart illustrating a further exemplary method for selecting application messages from an active feed adapter and a backup feed adapter for application-level data processing in a high speed, low latency data communications environment according to embodiments of the present invention that includes measuring (700) latency (702) of the active message stream and latency (704) of the backup message stream.

In the example of FIG. 7, the performance (502) of the active message stream (280) includes latency (702) of the active message stream (280). The latency (702) of the active message stream (280) may represent processing latency of the active message stream (280) or network latency of the active message stream (280). Processing latency of the active message stream (280) is the time period between when the transport engine of the subscribing client device receives an active transport packet and when the transport engine passes the active application messages encapsulated in the active transport packet to the computer software residing in the layer above the transport engine in the network protocol stack. Network latency of the active message stream (280) is the time period between the active feed adapter transmits an active transport packet and when the subscribing client device receives the active transport packet.

Similarly, the performance (504) of the backup message stream in the example of FIG. 7 includes latency (704) of the backup message stream (282). Similar to latency (702) of the active message stream (280), the latency (704) of the backup message stream (282) may represent processing latency of the backup message stream (282) or network latency of the backup message stream (282). Processing latency of the backup message stream (282) is the time period between when the transport engine of the subscribing client device receives a backup transport packet and when the transport engine passes the backup application messages encapsulated in the backup transport packet to the computer software residing in the layer above the transport engine in the network protocol stack. Network latency of the backup message stream (282) is the time period between the backup feed adapter transmits a backup transport packet and when the subscribing client device receives the backup transport packet.

Measuring (500), by the transport engine, performance (502) of the active message stream (280) and performance (504) of the backup message stream (282) according to the method of FIG. 7 includes measuring (700) latency (702) of the active message stream and latency (704) of the backup message stream. In the method of FIG. 7, measuring (700) latency (702) of the active message stream and latency (704) of the backup message stream may be carried out by measuring the processing latency of each message stream (280, 282) using the system clock of the subscribing client device. In the method of FIG. 7, measuring (700) latency (702) of the active message stream and latency (704) of the backup message stream may be carried out by measuring the processing latency of each message stream (280, 282) using the system clock of the subscribing client device to calculate the time period between when the transport engine of the subscribing client device receives a transport packet and when the transport engine passes the application messages encapsulated in the transport packet to the computer software residing in the layer above the transport engine in the network protocol stack. In the method of FIG. 7, measuring (700) latency (702) of the active message stream and latency (704) of the backup message stream may also be carried out by measuring the networking latency of each message stream (280, 282) using a transmission timestamp in an application message and the system clock of the subscribing client device to calculate time period between the backup feed adapter transmits a backup transport packet and when the subscribing client device receives the backup transport packet. When measuring the networking latency, the system clocks of the feed adapters and the subscribing client device may be synchronized through message streams (280, 282) or using a separate clock synchronization data communication channel.

The example of FIG. 7 also includes switching (506), by the transport engine, from further data processing with active application messages (404) to further data processing with the backup application messages (406) in dependence upon the performance (502) of the active message stream (280), the performance (504) of the backup message stream (282), and predetermined performance criteria (508). Switching (506), by the transport engine, from further data processing with active application messages (404) to further data processing with the backup application messages (406) in dependence upon the performance (502) of the active message stream (280), the performance (504) of the backup message stream (282), and predetermined performance criteria (508) according to the method of FIG. 7 may be carried out by switching, by the transport engine, from further data processing with active application messages (404) to further data processing with the backup application messages (406) if the difference between the latency (702) of the active message stream (280) and the latency (704) of the backup message stream (282) exceeds the predetermined performance criteria (508).

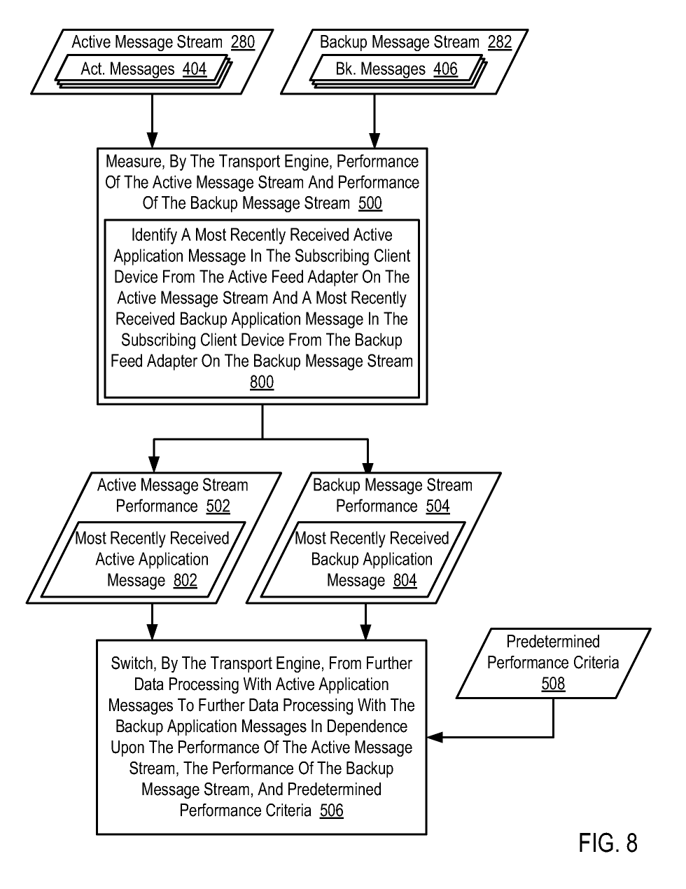

As mentioned above, measuring, by the transport engine, performance of the active message stream and performance of the backup message stream may be carried out by identifying the most recently received active transport packet in the subscribing client device from the active feed adapter on the active message stream and the most recently received backup transport packet in the subscribing client device from the backup feed adapter on the backup message stream. For further explanation, therefore, FIG. 8 sets forth a flowchart illustrating a further exemplary method for selecting application messages from an active feed adapter and a backup feed adapter for application-level data processing in a high speed, low latency data communications environment according to embodiments of the present invention that includes identifying (800) the most recently received active transport packet (802) in the subscribing client device from the active feed adapter on the active message stream (280) and the most recently received backup transport packet (804) in the subscribing client device from the backup feed adapter on the backup message stream (282).

In the example of FIG. 7, the performance (502) of the active message stream (280) includes a most recently received active transport packet (802) in the subscribing client device from the active feed adapter on the active message stream (280).

Similarly, the performance (504) of the backup message stream includes a most recently received backup transport packet (804) in the subscribing client device from the backup feed adapter on the backup message stream (282).

Measuring (500), by the transport engine, performance (502) of the active message stream (280) and performance (504) of the backup message stream (282) according to the method of FIG. 8 includes identifying (800) the most recently received active transport packet (802) in the subscribing client device from the active feed adapter on the active message stream (280) and the most recently received backup transport packet (804) in the subscribing client device from the backup feed adapter on the backup message stream (282). In the method of FIG. 8, identifying (800) the most recently received active transport packet (802) in the subscribing client device from the active feed adapter on the active message stream (280) and the most recently received backup transport packet (804) in the subscribing client device from the backup feed adapter on the backup message stream (282) may be carried out by identifying the active transport packet in an active packet buffer of the subscribing client device with the highest active packet sequence number and identifying the backup transport packet in a backup packet buffer of the subscribing client device with the highest backup packet sequence number.

The example of FIG. 8 also includes switching (506), by the transport engine, from further data processing with active application messages (404) to further data processing with the backup application messages (406) in dependence upon the performance (502) of the active message stream (280), the performance (504) of the backup message stream (282), and predetermined performance criteria (508). Switching (506), by the transport engine, from further data processing with active application messages (404) to further data processing with the backup application messages (406) in dependence upon the performance (502) of the active message stream (280), the performance (504) of the backup message stream (282), and predetermined performance criteria (508) according to the method of FIG. 8 may be carried out by switching, by the transport engine, from further data processing with active application messages (404) to further data processing with the backup application messages (406) if the difference between the most recently received active transport packet (802) and most recently received backup transport packet (804) exceeds the predetermined performance criteria (508).

In view of the explanations set forth above in this document, readers will recognize that practicing selecting application messages from an active feed adapter and a backup feed adapter for application-level data processing in a high speed, low latency data communications environment according to embodiments of the present invention provides the following benefits:
reducing data communications traffic on an active feed by utilizing application messages received from a backup feed adapter while an active feed adapter is operational,
reducing overall data communications traffic levels by reducing the number of retransmission requests from a subscribing client device to feed adapters, and
minimizing overall messaging latency by selecting application messages from an active feed adapter or alternatively from a backup feed adapter for application-level data processing.

Exemplary embodiments of the present invention are described largely in the context of a fully functional computer system for selecting application messages from an active feed adapter and a backup feed adapter for application-level data processing in a high speed, low latency data communications environment. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of selecting application messages from an active feed adapter and a backup feed adapter for application-level data processing in a high speed, low latency data communications environment, the method comprising:
brokering, by a stream administration server, establishment of an active message stream to a subscribing client device from an active feed adapter, the active message stream comprising active application messages;
brokering, by the stream administration server, establishment of a backup message stream to the subscribing client device from a backup feed adapter, the backup message stream comprising backup application messages representing duplicates of the active application messages;
receiving active transport packets in a transport engine of the subscribing client device from the active feed adapter, each active transport packet including one or more active application messages, each active transport packet characterized by an active packet sequence number, the active application messages from the active transport packets used for further data processing by an application of the subscribing client device;
receiving and buffering backup transport packets in the transport engine of the subscribing client device from the backup feed adapter, each backup transport packet including one or more backup application messages, each backup transport packet characterized by a backup packet sequence number and representing a duplicate of a corresponding active transport packet;
identifying, by the transport engine in dependence upon the active packet sequence numbers, a missing active transport packet;
determining, by the transport engine, whether a corresponding backup transport packet for the missing active transport packet has been received from the backup transport adapter; and
replacing, by the transport engine, the missing active transport packet with the corresponding backup transport packet for further data processing if the corresponding backup transport packet for the missing active transport packet has been received from the backup feed adapter.

2. The method of claim 1 wherein the high speed, low latency data communications environment comprises a high speed, low latency data communications network, the network further comprising the active feed adapter, the backup feed adapter, the stream administration server, at least one subscribing client device, and no router.

3. The method of claim 1 wherein each feed adapter comprises a device having the capabilities of converting messages on a feed adapter input stream having a first format to messages on a feed adapter output stream having a second format and transmitting the messages on the feed adapter output stream to subscribing client devices.

4. The method of claim 1 further comprising requesting, by the transport engine of the subscribing client device, retransmission of the missing active transport packet from at least one of the feed adapters if the corresponding backup transport packet for the missing active transport packet has not been received from the backup feed adapter.

5. The method of claim 1 further comprising:
measuring, by the transport engine, performance of the active message stream and performance of the backup message stream; and
switching, by the transport engine, from further data processing with active application messages to further data processing with the backup application messages in dependence upon the performance of the active message stream, the performance of the backup message stream, and predetermined performance criteria.

6. The method of claim 5 wherein:
the performance of the active message stream further comprises transmission errors of the active message stream;
the performance of the backup message stream further comprises transmission errors of the backup message stream; and
measuring, by the transport engine, performance of the active message stream and performance of the backup message stream further comprises measuring transmission errors of the active message stream and transmission errors of the backup message stream.

7. The method of claim 5 wherein:
the performance of the active message stream further comprises latency of the active message stream;
the performance of the backup message stream further comprises latency of the backup message stream; and
measuring, by the transport engine, performance of the active message stream and performance of the backup message stream further comprises measuring latency of the active message stream and latency of the backup message stream.

8. The method of claim 5 wherein:
the performance of the active message stream further comprises a most recently received active transport packet in the subscribing client device from the active feed adapter on the active message stream;
the performance of the backup message stream further comprises a most recently received backup transport packet in the subscribing client device from the backup feed adapter on the backup message stream; and
measuring, by the transport engine, performance of the active message stream and performance of the backup message stream further comprises identifying the most recently received active transport packet in the subscribing client device from the active feed adapter on the active message stream and the most recently received backup transport packet in the subscribing client device from the backup feed adapter on the backup message stream.

9. Apparatus for selecting application messages from an active feed adapter and a backup feed adapter for application-level data processing in a high speed, low latency data communications environment, the apparatus comprising one or more computer processors, one or more computer memories operatively coupled to the one or more computer processors, the computer memories having disposed within them computer program instructions capable of:
brokering, by a stream administration server, establishment of an active message stream to a subscribing client device from an active feed adapter, the active message stream comprising active application messages;
brokering, by the stream administration server, establishment of a backup message stream to the subscribing client device from a backup feed adapter, the backup message stream comprising backup application messages representing duplicates of the active application messages;
receiving active transport packets in a transport engine of the subscribing client device from the active feed adapter, each active transport packet including one or more active application messages, each active transport packet characterized by an active packet sequence number, the active application messages from the active transport packets used for further data processing by an application of the subscribing client device;
receiving and buffering backup transport packets in the transport engine of the subscribing client device from the backup feed adapter, each backup transport packet including one or more backup application messages, each backup transport packet characterized by a backup packet sequence number and representing a duplicate of a corresponding active transport packet;
identifying, by the transport engine in dependence upon the active packet sequence numbers, a missing active transport packet;
determining, by the transport engine, whether a corresponding backup transport packet for the missing active transport packet has been received from the backup transport adapter; and
replacing, by the transport engine, the missing active transport packet with the corresponding backup transport packet for further data processing if the corresponding backup transport packet for the missing active transport packet has been received from the backup feed adapter.

10. The apparatus of claim 9 wherein the high speed, low latency data communications environment comprises a high speed, low latency data communications network, the network further comprising the active feed adapter, the backup feed adapter, the stream administration server, at least one subscribing client device, and no router.

11. The apparatus of claim 9 wherein each feed adapter comprises a device having the capabilities of converting messages on a feed adapter input stream having a first format to messages on a feed adapter output stream having a second format and transmitting the messages on the feed adapter output stream to subscribing client devices.

12. The apparatus of claim 9 further comprising computer program instructions capable of requesting, by the transport engine of the subscribing client device, retransmission of the missing active transport packet from at least one of the feed adapters if the corresponding backup transport packet for the missing active transport packet has not been received from the backup feed adapter.

13. The apparatus of claim 9 further comprising computer program instructions capable of:
measuring, by the transport engine, performance of the active message stream and performance of the backup message stream; and
switching, by the transport engine, from further data processing with active application messages to further data processing with the backup application messages in dependence upon the performance of the active message stream, the performance of the backup message stream, and predetermined performance criteria.

14. A computer program product for selecting application messages from an active feed adapter and a backup feed adapter for application-level data processing in a high speed, low latency data communications environment, the computer program product disposed upon a signal bearing medium, the computer program product comprising computer program instructions capable of:
brokering, by a stream administration server, establishment of an active message stream to a subscribing client device from an active feed adapter, the active message stream comprising active application messages;
brokering, by the stream administration server, establishment of a backup message stream to the subscribing client device from a backup feed adapter, the backup message stream comprising backup application messages representing duplicates of the active application messages;
receiving active transport packets in a transport engine of the subscribing client device from the active feed adapter, each active transport packet including one or more active application messages, each active transport packet characterized by an active packet sequence number, the active application messages from the active transport packets used for further data processing by an application of the subscribing client device;
receiving and buffering backup transport packets in the transport engine of the subscribing client device from the backup feed adapter, each backup transport packet including one or more backup application messages, each backup transport packet characterized by a backup packet sequence number and representing a duplicate of a corresponding active transport packet;
identifying, by the transport engine in dependence upon the active packet sequence numbers, a missing active transport packet;
determining, by the transport engine, whether a corresponding backup transport packet for the missing active transport packet has been received from the backup transport adapter; and
replacing, by the transport engine, the missing active transport packet with the corresponding backup transport packet for further data processing if the corresponding backup transport packet for the missing active transport packet has been received from the backup feed adapter.

15. The computer program product of claim 14 wherein the signal bearing medium comprises a recordable medium.

16. The computer program product of claim 14 wherein the signal bearing medium comprises a transmission medium.

17. The computer program product of claim 14 wherein the high speed, low latency data communications environment comprises a high speed, low latency data communications network, the network further comprising the active feed adapter, the backup feed adapter, the stream administration server, at least one subscribing client device, and no router.

18. The computer program product of claim 14 wherein each feed adapter comprises a device having the capabilities of converting messages on a feed adapter input stream having a first format to messages on a feed adapter output stream having a second format and transmitting the messages on the feed adapter output stream to subscribing client devices.

19. The computer program product of claim 14 further comprising computer program instructions capable of requesting, by the transport engine of the subscribing client device, retransmission of the missing active transport packet from at least one of the feed adapters if the corresponding backup transport packet for the missing active transport packet has not been received from the backup feed adapter.

20. The computer program product of claim 14 further comprising computer program instructions capable of:
measuring, by the transport engine, performance of the active message stream and performance of the backup message stream; and
switching, by the transport engine, from further data processing with active application messages to further data processing with the backup application messages in dependence upon the performance of the active message stream, the performance of the backup message stream, and predetermined performance criteria.
